(19) United States
(12) Patent Application Publication
(10) Pub. No.: US 2014/0144330 A1
(43) Pub. Date: May 29, 2014

(54) DRIP FILTER COFFEE MAKER

(71) Applicant: YUN CHENG HUANG, KAOHSIUNG CITY (TW)

(72) Inventor: YUN CHENG HUANG, KAOHSIUNG CITY (TW)

(21) Appl. No.: 14/087,205

(22) Filed: Nov. 22, 2013

(30) Foreign Application Priority Data
Nov. 27, 2012 (TW) 101144254

(51) Int. Cl. A47J 31/46

(52) U.S. Cl. CPC A47J 31/46
USPC 99/300

(57) ABSTRACT

The disclosure provides a drip filter coffee maker. The tilting rod assembly includes a tilting rod motor and a tilting rod driven by the tilting rod to repeatedly swing within a predetermined angle range, and a top end of the tilting rod performs helical rotation. The connecting rod assembly has a connecting rod driven by the tilting rod. The water injecting pipe assembly has a water injecting pipe driven by the connecting rod. By the connecting rod, the helical rotation of the top end of the tilting rod is transferred to the water injecting pipe, and the water injecting pipe performs helical water injection. Hot water is poured repeatedly and uniformly onto the coffee powder along a helical path. Therefore, the coffee powder is uniformly mixed with the water, and coffee with a more mellow taste is obtained.

### BACKGROUND OF THE INVENTION

1. Field of the Invention

The present disclosure relates to a drip filter coffee maker, and more particularly to a drip filter coffee maker having helical water injection.

2. Description of the Related Art

Generally, a conventional drip filter coffee maker fills water from a fixed position, so it is difficult to uniformly mix the coffee powder with water.

### SUMMARY OF THE INVENTION

The present disclosure provides a drip filter coffee maker. The drip filter coffee maker of the disclosure includes a rotational base assembly, a tilting rod assembly, a connecting rod assembly and a water injecting pipe assembly. The rotational base assembly includes a rotational base and a base motor, the rotational base is driven by the base motor to rotate. The tilting rod assembly is mounted on the rotational base, and includes a tilting rod motor and a tilting rod. The tilting rod motor drives the tilting rod to repeatedly swing within a predetermined angle range, and a top end of the tilting rod performs helical rotation. The connecting rod assembly has a connecting rod driven by the tilting rod. The water injecting pipe assembly has a water injecting pipe driven by the connecting rod. By the connecting rod, the helical rotation of the top end of the tilting rod is transferred to the water injecting pipe to perform helical rotation, and the water injecting pipe performs helical water injection.

The drip filter coffee maker of the present disclosure utilizes the water injecting pipe to inject water in a helical rotation manner so as to repeatedly and uniformly pour hot water onto the coffee powder along a helical path. Therefore, the coffee powder is uniformly mixed with the water, and coffee with a more mellow taste is obtained.

### BRIEF DESCRIPTION OF THE DRAWINGS

FIG. 1 shows a schematic perspective view of a drip filter coffee maker according to some embodiments;

FIG. 2 shows a schematic view of a drip filter coffee maker according to some embodiments;

FIG. 3 shows a schematic perspective view of a rotational base assembly according to some embodiments;

FIG. 4 shows a schematic perspective view of a tilting rod assembly according to some embodiments;

FIG. 5 shows a schematic view illustrating helical rotation of a top end of a tilting rod according to some embodiments;

FIG. 6 shows a schematic perspective view of a connecting rod assembly and a water injecting pipe assembly according to some embodiments; and

FIG. 7 shows a schematic operation view illustrating helical water injection according to some embodiments.

### DETAILED DESCRIPTION OF THE INVENTION

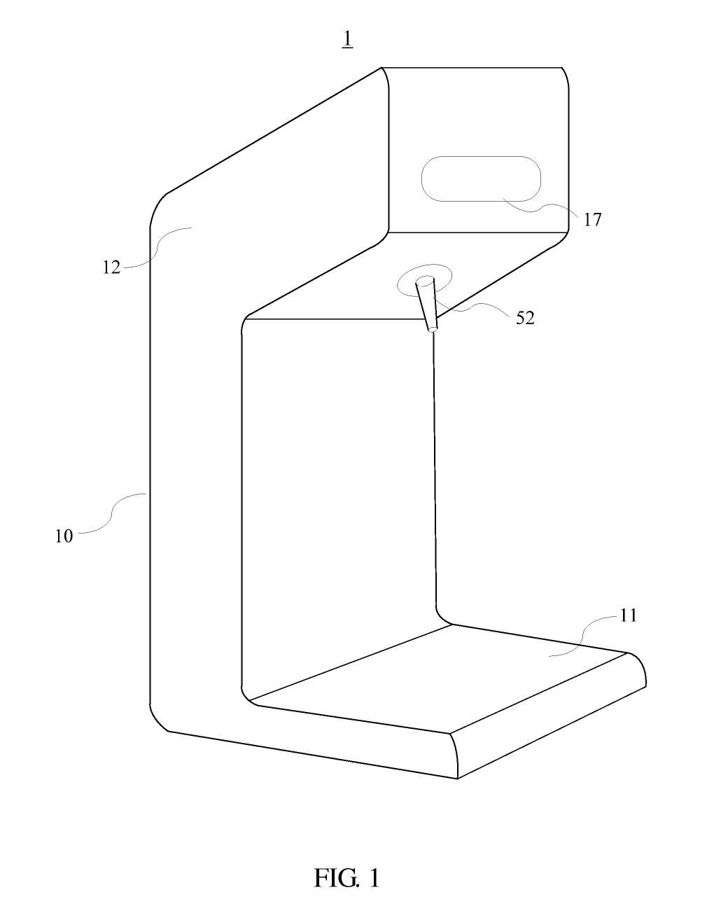

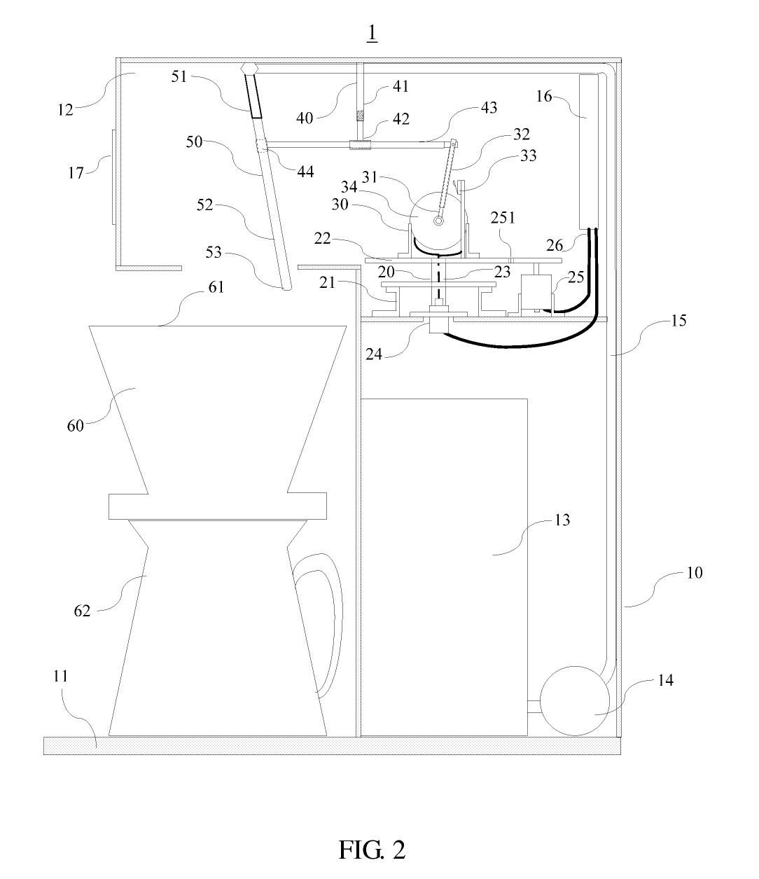

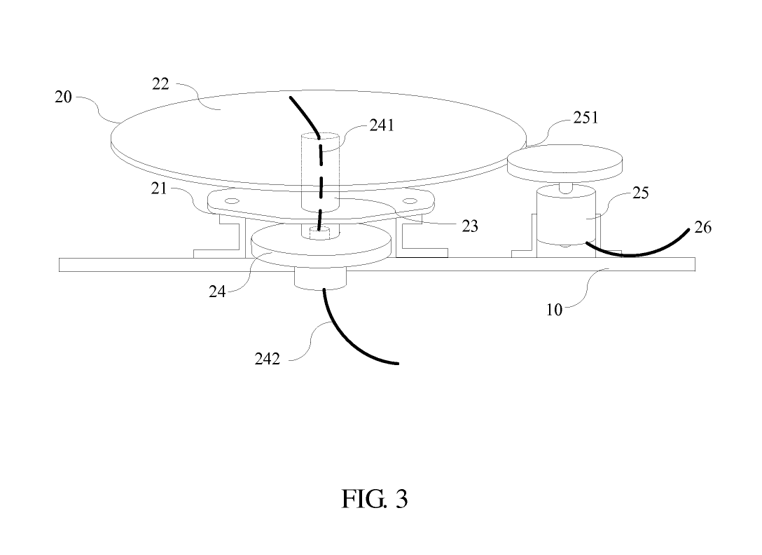

Referring to FIG. 1, FIG. 2 and FIG. 3, the present disclosure provides a drip filter coffee maker 1 having helical water injection. The drip filter coffee maker 1 includes a body 10, a rotational base assembly 20, a tilting rod assembly 30, a connecting rod assembly 40 and a water injecting pipe assembly 50. The body 10 includes a cup seat 11, an upper base 12, a water tank 13, a water pump 14, and a water pump outlet pipe 15. The rotational base assembly 20 is mounted in the upper base 12. The rotational base assembly 20 has a rotational base 22 and a base motor 25. The base motor 25 drives the rotational base 22 to rotate through gear engagement with a transmission assembly 251. The rotational base 22 is fixed by a rotational base support frame 21. A rotational shaft 23 of the rotational base 22 is hollow for a rotational wire 241 to pass through. A rotational wire adapter 24 is connected to the rotational wire 241. The rotational wire 241 can rotate with the rotational base 22 and connect to the tilting rod assembly 30. A fixed wire 242 connected to the rotational wire adapter 24 is coupled to a control panel 16. By using the rotational wire adapter 24, the entwined situation on the fixed wire 242 can be avoided.

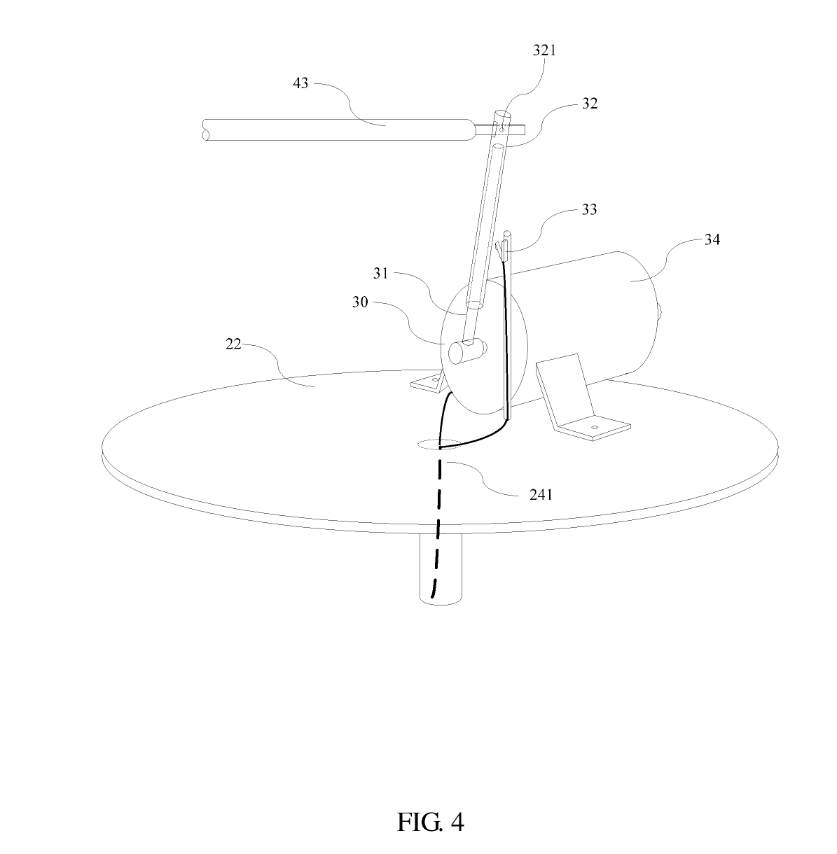

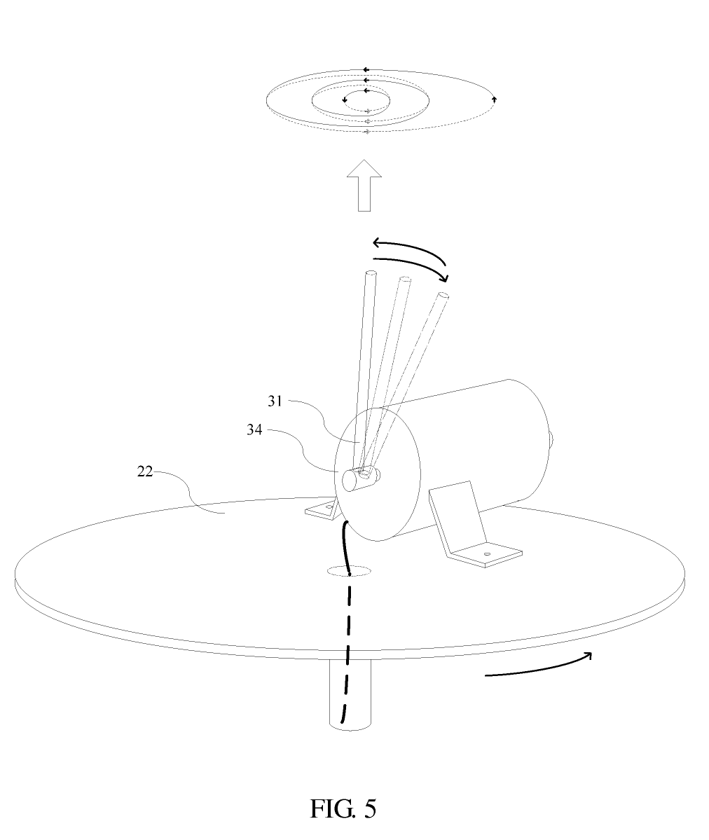

Referring to FIG. 4 and FIG. 5, the tilting rod assembly 30 is mounted on the rotational base 22, and the tilting rod assembly 30 rotates with the rotational base 22. The tilting rod assembly 30 has a tilting rod motor 34 and a tilting rod 31. A power source of the tilting rod motor 34 is coupled to the rotational wire 241. A rotational shaft of the tilting rod motor 34 is located on a central vertical axis of the rotational base 22. The tilting rod 31 is substantially straight and mounted on the rotational shaft of the tilting rod motor 34. A limit switch 33 is mounted on one side of the tilting rod 31 and capable of limiting a tilting range of the tilting rod 31. A contact of the limit switch 33 is coupled to the rotational wire 241. The tilting rod 31 is enabled to repeatedly tilt and recover to a straight state at an appropriate speed by properly adapting to forward and reverse rotation speeds of the tilting rod motor 34, that is, the tilting rod 31 repeatedly swings in a predetermined angle range, the predetermined angle is determined by the limit switch, and a top end of the tilting rod 31 can achieve helical rotation effect through the rotation of the rotational base 22.

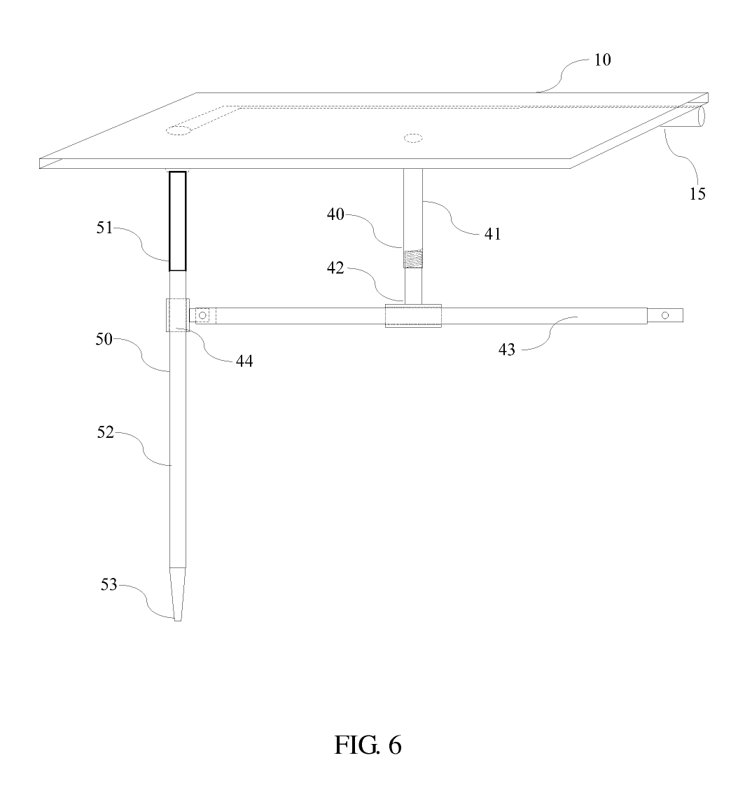

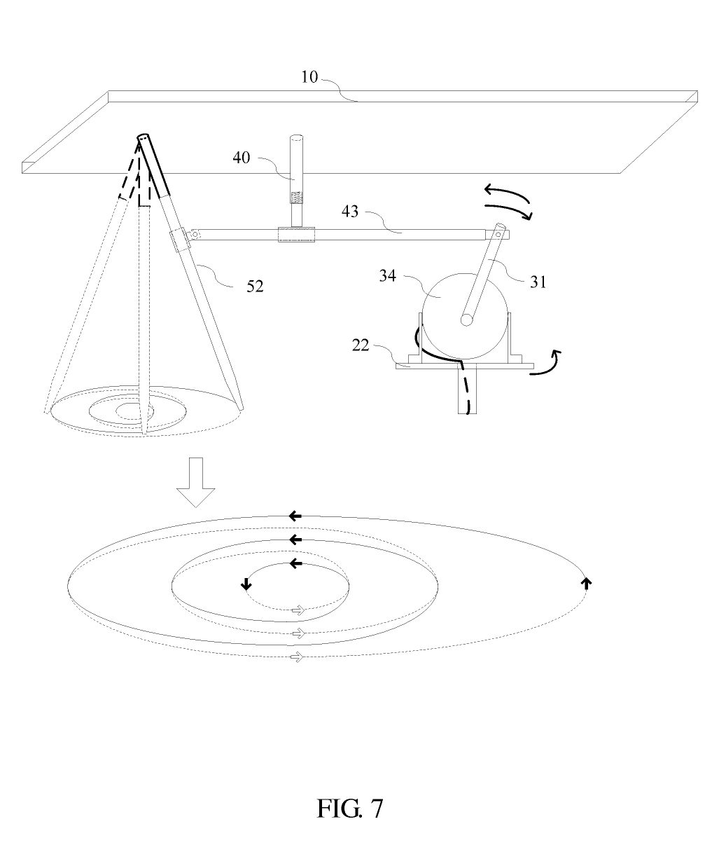

Referring to FIG. 4, FIG. 6 and FIG. 7, the tilting rod 31 is fitted in a sleeve cylinder 32, and the sleeve cylinder 32 can slide up and down freely and rotate along the tilting rod 31. The connecting rod assembly 40 includes a connecting rod 43 driven by the tilting rod 31 indirectly or directly. In an embodiment, the connecting rod 43 is driven by the tilting rod 31 and the sleeve cylinder 32. For example, an upper end of the sleeve cylinder 32 is connected to the connecting rod 43, and the connecting rod 43 can swing up and down in a horizontal direction within a certain angle range, that is, the connecting rod 43 swings up and down in a horizontal axial direction of the sleeve cylinder 32 within a second predetermined angle range.

A middle section of the connecting rod 43 passes through the hollow part of a sleeve pipe 42, the connecting rod 43 can slide in the sleeve pipe 42. A male thread on an upper end of the sleeve pipe 42 is screwed with a female thread of a support base 41 so that the sleeve pipe 42 can rotate in a horizontal direction. The other end of the connecting rod 43 is connected to one end of a connector 44, and the connector 44 can swing up and down in a horizontal direction of the connecting rod 43 within a certain angle range, that is, the connector 44 swings up and down in a horizontal axial direction of the connecting rod 43 within a third predetermined angle range.

The water injecting pipe assembly 50 includes a water injecting pipe 52 driven by the connecting rod 43 indirectly or directly. In an embodiment, the water injecting pipe 52 is driven by the connecting rod 43 and the connector 44. For example, the other end of the connector 44 is hollow and fitted with the water injecting pipe 52, that is, the water injecting pipe 52 passes through the other end of the connector 44. The connector 44 can slide up and down along the water injecting pipe 52 and the water injecting pipe 52 can rotate in the other end of the connector 44. The water injecting pipe 52 can rotate in a helical manner along a vertical axial direction. An upper end of the water injecting pipe 52 is connected to a hose 51, one end of the hose 51 is connected to the water pump outlet pipe 15, and the flexibility of the hose 51 is sufficient for helical rotation of the water injecting pipe 52, so that the helical rotation effect of the top end of the tilting rod 31 is transferred to the water injecting pipe 52 by the connecting rod 43, and a water injecting pipe outlet 53 rotates in a helical manner.

The control panel 16 receives an instruction from an operation panel 17, and controls the base motor 25 to rotate, the tilting rod motor 34 to repeatedly perform forward and reverse rotation at an appropriate speed within a certain angle. The water pump 14 works. Therefore, hot water is delivered through the water pump outlet pipe 15 to the water injecting pipe assembly 50, thereby achieving the purpose of helical water injection.

Referring to FIG. 2, the coffee maker having helical water injection is obtained by assembling the foregoing mechanisms. In an embodiment, when the coffee maker is used, hot water is first filled in the water tank 13, filter paper 61 is laid on a filter bowl 60, coffee powder is placed on the filter paper 61, and a stewing mode is set on the operation panel 17. Before injecting water, the control panel 16 first drives the tilting rod 31 to reach a vertical position, and propels the water injecting pipe 52 to reach a central position of the filter bowl 60. After that, the control panel 16 controls the water pump 14 to work, the base motor 25 to rotate, and the tilting rod motor 34 to repeatedly perform forward and reverse rotation at an appropriate speed within a certain angle, so that the tilting rod 31 rotates in a helical manner. By the connecting rod assembly 40, the water injecting pipe 52 is driven to rotate and inject water in a helical manner. In this way, the water injecting pipe outlet 53 can repeatedly and uniformly pour the hot water onto the coffee powder along a helical path according to the center of the filter bowl 60, so that the coffee powder is uniformly mixed with the water and finally the coffee liquid flows into a coffee collector cup 62; therefore, coffee with a more mellow taste is obtained.

While several embodiments of the present disclosure have been illustrated and described, various modifications and improvements can be made by those skilled in the art. The embodiments of the present disclosure are therefore described in an illustrative but not in a restrictive sense. It is intended that the present disclosure should not be limited to the particular forms as illustrated and that all modifications which maintain the spirit and scope of the present disclosure are within the scope defined in the appended claims.

What is claimed is:

1. A drip filter coffee maker, comprising:
a rotational base assembly, comprising a rotational base and a base motor, the rotational base being driven by the base motor to rotate;
a tilting rod assembly, mounted on the rotational base and comprising a tilting rod motor and a tilting rod, the tilting rod motor driving the tilting rod to repeatedly swing within a predetermined angle range, wherein a top end of the tilting rod performs helical rotation;
a connecting rod assembly, having a connecting rod driven by the tilting rod; and
a water injecting pipe assembly, having a water injecting pipe driven by the connecting rod, by the connecting rod the helical rotation of the top end of the tilting rod transferring to the water injecting pipe to perform helical rotation, wherein the water injecting pipe performs helical water injection.

2. The drip filter coffee maker according to claim 1, wherein the rotational base assembly further comprises a transmission assembly, a rotational wire adapter and a rotational base support frame; the rotational base is fixed by the rotational base support frame, the base motor drives the rotational base to rotate through the transmission assembly, a rotational shaft of the rotational base is hollow, the rotational wire adapter is connected to a rotational wire rotating with the rotational base and reaches up to the rotational base through the hollow rotational shaft, and the rotational wire adapter is connected to a fixed wire coupled to a control panel.

3. The drip filter coffee maker according to claim 1, wherein the tilting rod assembly is mounted on the rotational base assembly, the tilting rod is substantially straight and mounted on a rotational shaft of the tilting rod motor, and the rotational shaft of the tilting rod motor is located on a central vertical axis of the rotational base.

4. The drip filter coffee maker according to claim 3, wherein the tilting rod assembly further comprises a sleeve cylinder and a limit switch, the limit switch is mounted on one side of the tilting rod to determine the predetermined angle of the tilting rod, the tilting rod is fitted in the sleeve cylinder, and the sleeve cylinder is capable of rotating and sliding up and down along the tilting rod.

5. The drip filter coffee maker according to claim 4, wherein one end of the connecting rod is connected to the sleeve cylinder of the tilting rod assembly, and the connecting rod swings up and down in a horizontal axial direction of the sleeve cylinder within a second predetermined angle range.

6. The drip filter coffee maker according to claim 5, wherein the connecting rod assembly further comprises a support base and a sleeve pipe, the sleeve pipe is connected to the support base, the sleeve pipe is capable of rotating in a horizontal direction, and a middle section of the connecting rod passes through a hollow part of the sleeve pipe, the connecting rod slides in the sleeve pipe.

7. The drip filter coffee maker according to claim 5, wherein the connecting rod assembly further comprises a connector, and one end of the connector is connected to the other end of the connecting rod, the connector swings up and down in a horizontal axial direction of the connecting rod within a third predetermined angle range, and the other end of the connector is hollow.

8. The drip filter coffee maker according to claim 7, wherein the water injecting pipe passes through the other end of the connector, and the connector slides up and down along the water injecting pipe and the water injecting pipe rotates in the other end of the connector, the water injecting pipe rotates in a helical manner along a vertical axial direction.

9. The drip filter coffee maker according to claim 1, wherein the water injecting pipe assembly further comprises a hose, one end of the hose is connected to a water pump outlet pipe, the other end of the hose is connected to the water injecting pipe, and the flexibility of the hose is sufficient for helical rotation of the water injecting pipe.
